(19) United States
(12) Patent Application Publication
(10) Pub. No.: US 2005/0216836 A1
(43) Pub. Date: Sep. 29, 2005

(54) Electronic document processing

(75) Inventors: Mark Duke, Surrey (GB); Kristian Wright, London (GB); Tharmavathanan Tharmalingam, Middlesex (GB)

Correspondence Address: HESLIN ROTHENBERG FARLEY & MESITI PC, 5 COLUMBIA CIRCLE, ALBANY, NY, 12203, US

(73) Assignee: TripleArc UK Limited, London (GB)

(21) Appl. No.: 11/053,205

(22) Filed: Feb. 8, 2005

Related U.S. Application Data
(63) Continuation of application No. PCT/GB03/03486, filed on Aug. 8, 2003.

(30) Foreign Application Priority Data
Aug. 9, 2002 (GB) GB 0218576.7

(51) Int. Cl. G06F 17/00

(52) U.S. Cl. 715/531; 715/513

(57) ABSTRACT

A first electronic document is processed to produce a second electronic document. The second electronic document is an edited version of the first electronic document. The processing of the first electronic document includes using computer software to produce the second electronic document.

### CROSS-REFERENCE TO RELATED APPLICATIONS

This application is a continuation of PCT Application PCT/GB2003/003486, filed Aug. 8, 2003, and published under the PCT Articles in English as WO 2004/015588 A2 on Feb. 19, 2004. PCT/GB2003/003486 claimed priority to Great Britain Application No. GB 0218576.7, filed Aug. 9, 2002. The entire disclosures of PCT/GB2003/003486 and Great Britain Serial No. GB 0218576.7 are incorporated herein by reference in their entirety.

### TECHNICAL FIELD

The present invention relates to electronic document processing, in particular, but not exclusively, to a system for the processing a first electronic document using computer software to produce a second electronic document which is an edited version of the first electronic document.

### BACKGROUND OF THE INVENTION

The Adobe™ Portable Document Format (PDF) is a file format for representing documents in a manner independent of the application software, hardware, and operating system used to create them and of the output device on which they are to be displayed or printed. A PDF document consists of a collection of objects that together describe the appearance of one or more pages, possibly accompanied by additional interactive elements and higher-level application data. A PDF file contains the content making up a PDF document along with associated structured information defining content presentation attributes. Adobe Acrobat™ software allows a PDF document to be edited, but such editing is limited to minor textual changes, for example the correction of typographical errors. Software plug-ins allow additional restricted textual editing and the limited editing of image objects, for example the ability to change color space.

The Acrobat software also includes functionality for the production and editing of editable PDF forms. However, a significant inhibitor to the creation of useful editable desktop publishing (DTP) assets, including editable PDF forms, is the amount of work involved in setting up a file as a ‘template’ and the experience required.

International patent publication WO 02/01403 describes a system for producing a PDF document by combining two eXtensible Markup Language (XML) files. A drawback of such a system is that it requires relatively extensive set-up from an administrator point of view.

International patent publication WO 01/59696 describes an editable PDF production system. Variable paragraphs are provided in the form of containers ‘drawn’ by the administrator to indicate where user-input text (or images) can go on the page. These containers can have specific attributes (tags) such as font, size, color attributes etc. that can be applied. These ‘frames’ are used in much the same way as a page layout program, i.e. the layout is built up using ‘frames’ to which an administrator manually applies attributes e.g. font style, color etc. Again, the system requires relatively extensive set-up from an administrator point of view.

### SUMMARY OF THE INVENTION

It is an object of the present invention to overcome the drawbacks associated with known methods of producing and editing document templates via desktop publishing applications.

In accordance with one aspect of the present invention, there is provided a method of processing a first electronic document using computer software to produce a second electronic document which is an edited version of the first electronic document, wherein the first and second electronic documents define the presentation of elements on at least one page when presented on an output device, the documents each comprising a plurality of text objects to be presented as textual elements in a page, the text objects comprising original text defining a plurality of textual characters, and having associated therewith original presentation attributes defining characteristics of the presentation of the original text of the text object on a page. The method includes, for instance, in a template production process, using computer software to generate a document template by processing the first electronic document, selecting at least a first said text object in the first electronic document and associating one or more template attributes with the first text object, said one or more template attributes not being explicitly defined in the first document before the production of the template; and in an editing process, using computer software to receive replacement text to: replace at least part of the original text of the first text object; automatically generate a second text object using the replacement text and one or more of the original presentation attributes of the first text object; and automatically generate the second electronic document, which includes the second text object, such that the second electronic document accords with the document template.

Further aspects of the invention are set out in the appended claims.

By use of the present invention, an administrator may conveniently re-purpose existing DTP assets in a simple manner, preferably within a PDF environment. A template may be specified by an administrator using automated processing directly using an original document. The template may be used in further automated processing by a user to create an edited document in a simple manner.

The invention provides automated processes for directly manipulating the document content without the need for the creation of an intermediary format such as XML to facilitate content editing. Having a document template created specifically for use with an original file, a user can produce an edited document having variations according with predefined template attributes, which variations are created by the assistance of automated processing. The automated processing may provide functions such as automated word wrapping, text resizing, text repositioning, and other text manipulations.

By use of the present invention, both the creation of a template and the creation of an edited document can be simplified significantly. Document processing may be conducted by extracting and characterizing text content which exists in the text objects of the document and maintaining or altering characteristics of the text presentation attributes already in existence in a controlled manner to produce replacement text objects. Image objects may also be manipulated in a controlled manner.

Additional features and advantages are realized through the techniques of the present invention. Other embodiments and aspects of the invention are described in detail herein and are considered a part of the claimed invention.

### BRIEF DESCRIPTION OF THE DRAWINGS

Further features and advantages of the present invention will be understood from the description of preferred embodiments of the invention, given below by way of example only, made with reference to the accompanying drawings, wherein:

FIG. 1 is a schematic illustration of a document processing system arranged in accordance with an embodiment of the invention;

FIG. 2 is a view of a page of a document to be edited in accordance with an embodiment of the invention;

FIG. 3 is a flow diagram of a template production process arranged in accordance with an embodiment of the invention;

FIG. 4 is a view of a template summary Web page arranged in accordance with an embodiment of the invention;

FIG. 5 is a view of a text object template editing Web page arranged in accordance with an embodiment of the invention;

FIG. 6 is a view of an image object template editing Web page arranged in accordance with an embodiment of the invention;

FIG. 7 is a flow diagram of a document editing process arranged in accordance with an embodiment of the invention;

FIG. 8 is a view of an object editing Web page arranged in accordance with an embodiment of the invention;

FIGS. 9(A) and 9(B) show a flow diagram of text object manipulation software routines arranged in accordance with an embodiment of the invention; and

FIG. 10 is a view of a page of a document edited in accordance with an embodiment of the invention.

### BEST MODEM FOR CARRYING OUT THE INVENTION

In preferred embodiments of the invention, use is made of the PDF format. The following description of aspects of the PDF format is based in part on “PDF reference: Adobe portable document format version 1.4”, Adobe Systems Incorporated, Third Edition, December 2001. The remainder of the above document is incorporated herein, in particular those parts relating to the PDF text presentation facilities, by reference.

A PDF document's pages may contain any combination of text, graphics, and image objects. A PDF document contains a sequence of objects to be presented on the page. To support random access to individual objects in a document, every PDF file contains a cross-reference table giving byte offsets that are used by an application to locate objects within the file.

Various facilities are provided in PDF for dealing with text—specifically, for representing characters with glyphs from fonts. A character is an abstract symbol, whereas a glyph is a specific graphical rendering of a character. For example, the glyphs A, A, and A are renderings of the abstract “A” character.

Glyphs are organized into fonts. A font defines glyphs for a particular character set. A glyph is a graphical shape and is subject to graphical manipulations, such as coordinate transformation.

A subset of the graphics state parameters in PDF, referred to as text state parameters, pertain to text, including parameters that select the font, scale the glyphs to an appropriate size, and accomplish other graphical effects.

Text operators specify the glyphs to be painted, represented by string objects whose values are interpreted as sequences of character codes. A text object encloses a sequence of text operators and associated parameters.

Font dictionaries and associated data structures provide information that a viewer application needs to interpret the text and position the glyphs properly. The definitions of the glyphs themselves are contained in font programs, which may be embedded in the PDF file, built into the viewer application, or obtained from an external font file.

A content stream presents glyphs on a page by specifying a font dictionary and a string object that is interpreted as a sequence of one or more character codes identifying glyphs in the font. This operation is called showing the text string. The glyph description consists of a sequence of graphics operators that produce the specific shape for that character in this font. To render a glyph, the presenter application executes the glyph description.

Example 1 below illustrates a simple text object as described in a PDF document. It presents the text ABC on the page with a start point ten inches from the bottom of the page and four inches from the left edge, using 12-point Helvetica.

### EXAMPLE 1

BT
/F13 12 Tf
288 720 Td
(ABC) Tj

ET

The five lines of this example perform the following steps:
1. Begin a text object.
2. Set the font and font size to use, installing them as parameters in the text state. (The font resource identified by the name F13 specifies a font, in this example one externally known as Helvetica.)
3. Specify a starting position on the page, setting parameters in the text object.
4. Present the glyphs for a string of characters there.
5. End the text object.

To present glyphs, a content stream must first identify the font to be used. The Tf operator specifies the name of a font resource—that is, an entry in the Font subdictionary of the current resource dictionary. The value of that entry is a font dictionary. The font dictionary in turn identifies the font's externally known name, such as Helvetica, and supplies some additional information that the viewer application needs to paint glyphs from that font; it optionally provides the definition of the font program itself.

A glyph's width in text space is the distance the current text position moves (by translating text space) when the glyph is presented. Note that the width is distinct from the dimensions of the glyph outline. Note also that a glyph width in user space is also distinct from the glyph width in text space; the width in user space is further dependent on other attributes such as the font size.

In some fonts, the glyph width is constant; it does not vary from glyph to glyph. Such fonts are called fixed-pitch or monospaced. They are used mainly for typewriter-style printing. However, most fonts used for high-quality typography associate a different width with each glyph. Such fonts are called proportional or variable-pitch fonts. In either case, the Tj operator positions the glyphs for consecutive characters of a string according to their widths.

Thus, a PDF text object consists of operators that can show text strings, move the text position, and set text state and certain other parameters. In addition, there are three parameters that are defined only within a text object and do not persist from one text object to the next:
Tₘ, the text matrix;
Tₗₘ, the text line matrix; and
Tᵣₘ, the text rendering matrix, an intermediate result that combines the effects of text state parameters, the text matrix Tₘ, and the current transformation matrix.

The specific categories of text-related operators that can appear in a text object are:
Text state operators;
Text-positioning operators; and
Text-showing operators.
The other operators that can appear in a text object are those related to the general graphics state, color, and marked content.

The text state describe presentation attributes that affect text. There are nine parameters in the text state:
T_{c} Character spacing
T_{w} Word spacing
Tₕ Horizontal scaling
Tₗ Leading
T_{f} Text font
T_{fs} Text font size
T_{mode} Text rendering mode
Tᵣᵢₛₑ Text rise
Tₖ Text knockout

The text state operators can appear inside and outside text objects, and the values they set may be retained across text objects in a single content stream. These parameters are initialized to their default values at the beginning of each page.

The text state operators are given in Table 1 below.

TABLE 1
Text state operators

| | |
|---|---|
| Tc | Sets the character spacing, T_{c}, to charSpace, which is a number |
| | expressed in unscaled text space units. |
| Tw | Sets the word spacing, T_{w}, to wordSpace, which is a number |
| | expressed in unscaled text space units. |
| Tz | Sets the horizontal scaling, Tₕ, to (scale ÷ 100). |
| TL | Sets the text leading, T₁, to leading, which is a number expressed in |
| | unscaled text space units. |
| Tf | Sets the text font, T_{f}, to font and the text font size, T_{fs}, to size. |
| Tr | Sets the text rendering mode, T_{mode}, to render. |
| Ts | Sets the text rise, Tᵣᵢₛₑ, to rise. |

Text space is the coordinate system in which text is shown. The text matrix, Tₘ, and the text state parameters T_{fs}, Tₕ, and Tᵣᵢₛₑ, together determine the transformation from text space to user space. Specifically, the origin of the first glyph shown by a text-showing operator will be placed at the origin of text space. If text space has been translated, scaled, or rotated, then the position, size, or orientation of the glyph in user space will be correspondingly altered.

At the beginning of a text object, Tₘ is the identity matrix, so the origin of text space is initially the same as that of user space. The text-positioning operators, described in Table 2 below, alter Tₘ and thereby control the placement of glyphs that are subsequently painted. Also, the text-showing operators, described in Table 3 below, update Tₘ (by altering its e and f translation components) to take into account the horizontal or vertical displacement of each glyph painted as well as any character or word spacing parameters in the text state.

TABLE 2
Text-positioning operators

| OPERANDS | OPERATOR | DESCRIPTION |
|---|---|---|
| tₓ t_{y} | Td | Move to the start of the next line, offset |
| | | from the start of the current line by (tₓ, |
| | | t_{y}). tₓ and t_{y} are numbers |
| | | expressed in unscaled text space units. |
| | | More precisely, this operator performs |
| | | the following assignments: |
| | | ${T}_{m} = {T}_{lm} = [ \begin{matrix}1 & 0 & 0 \\ 0 & 1 & 0 \\ {t}_{x} & {t}_{y} & 1\end{matrix} ] \times {T}_{lm}$ |
| tₓ t_{y} | TD | Move to the start of the next line, offset |
| | | from the start of the current line by (tₓ, |
| | | t_{y}). As a side effect, this operator sets |
| | | the leading parameter in the text state. |
| | | This operator has the same effect as the |
| | | code −t_{y} TL |
| | | tₓ t_{y} Td |
| a b c d e f | Tm | Set the text matrix, Tₘ, and the text line |
| | | matrix, Tₗₘ, as follows: |
| | | ${T}_{m} = {T}_{lm} = [ \begin{matrix}a & b & 0 \\ c & d & 0 \\ e & f & 1\end{matrix} ]$ |
| | | The operands are all numbers, and the |
| | | initial value for Tₘ and Tₗₘ is |
| | | the identity matrix, [1 0 0 1 0 0]. |
| | | Although the operands specify a matrix, |
| | | they are passed to Tm as six separate |
| | | numbers, not as an array. |
| | | The matrix specified by the operands is |
| | | not concatenated onto the current text |
| | | matrix, but replaces it. |
| − | T* | Move to the start of the next line. |

Text-showing operators (examples are given in Table 3 below) show text on the page, repositioning text space as they do so. The text-showing operators interpret the text string and apply the relevant text state parameters.

TABLE 3
Text-showing operators

| OPERANDS | OPERATOR | DESCRIPTION |
|---|---|---|
| string | Tj | Show a text string. |
| array | TJ | Show one or more text strings, allowing |
| | | individual glyph positioning. Each element |
| | | of array can be a string or a number. If the |
| | | element is a string, this operator shows the |
| | | string. If it is a number, the operator adjusts |
| | | the text position by that amount; that is, it |
| | | translates the text matrix, Tₘ. The number is |
| | | expressed in thousandths of a unit of text |
| | | space. This amount is subtracted from the |
| | | current horizontal or vertical coordinate, |
| | | depending on the writing mode. In the |
| | | default coordinate system, a positive |
| | | adjustment has the effect of moving the next |
| | | glyph painted either to the left or down |
| | | by the given amount. |

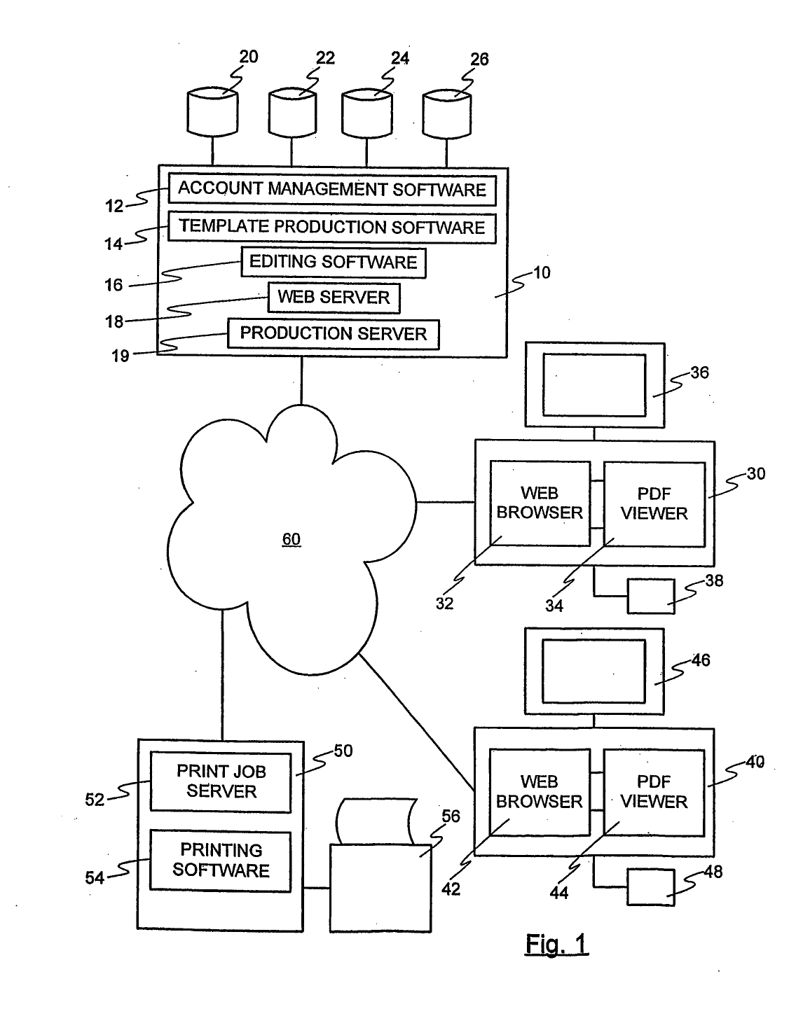

FIG. 1 illustrates an electronic document processing system arranged in accordance with one embodiment of the invention. The system includes an application service provider (ASP) system 10, one or more administrator terminals 30, one or more user terminals 40 and one or more print facilities 50.

The ASP system 10 includes data processing apparatus in the form of one or more network servers, which may be co-located or remotely located, for running various elements of computer software. The computer software includes account management software 12, template production software 14, editing software 16, web server software 18 and production server 19. The ASP system 10 further includes various data stores for holding electronic documents and data relating to those electronic documents. The data stores include an original PDF database table 20, a template image database table 22, a document template database table 24 and an edited PDF database table 26.

An administrator terminal 30 is in the form of a standard computer workstation, such as a personal computer, having a Web browser software application 32, for example Microsoft Internet Explorer™ installed thereon in combination with a PDF viewer plug-in software application 34, such as Adobe Acrobat™ reader. The terminal also includes an image output device 36, such as a cathode ray tube or a flat-screen liquid crystal display, and an input-output device or devices 38, such as a keyboard and/or a mouse.

A user terminal 40 is similarly arranged to an administrator terminal 30, being a data processing workstation including Web browser software 42 and a PDF viewer plug-in 44 installed thereon, a display device 46 and input-output equipment 48 attached thereto.

A print facility 50 includes data processing apparatus, for example one or more network servers, having print job server computer software 52 installed thereon and printing software 54 installed thereon, whereby printing apparatus 56 is controlled in accordance with print jobs received by print job server 52.

All of the elements of the processing and communications system are preferably interconnected by a public data communications network 60, such as the Internet. Alternatively, some or all of the elements may be interconnected by a private data network or a virtual private network (VPN).

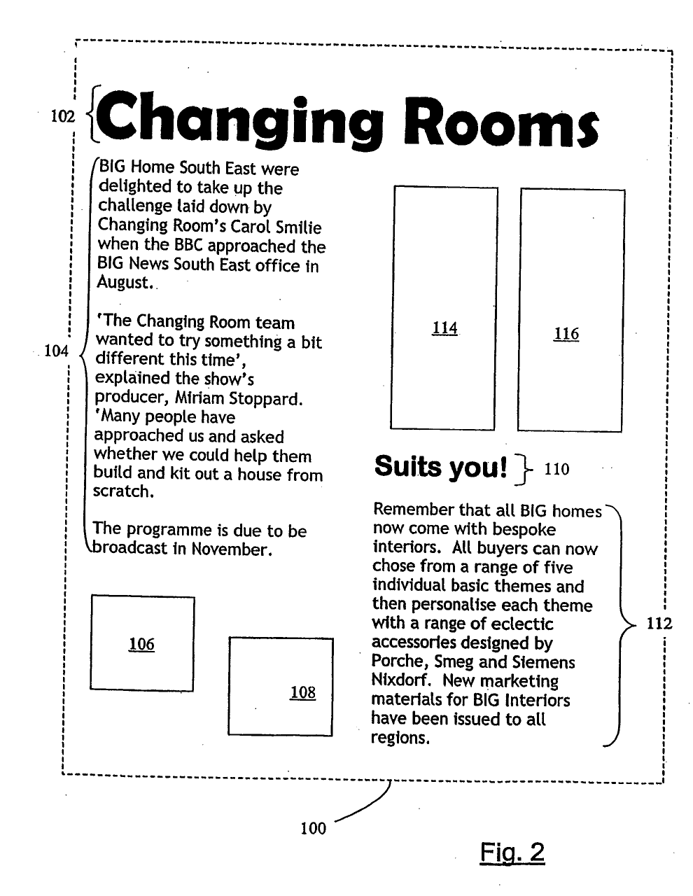

FIG. 2 illustrates an exemplary page 100 presented in accordance with an original PDF document which may be processed using the processing and communications system illustrated in FIG. 1. The original PDF document may be produced using a desktop publishing software application, such as QuarkXPress™. The designer of the document may use the desktop publishing software to edit the text, graphical and image content of the document using the editing facilities provided in the software. Once the document has been designed, the document is converted to a Postscript™ file, which is then distilled to create a PDF file. The document is then saved in the ASP system as an original PDF file. The original PDF file is generally in the form of a print-ready high resolution PDF file, from which multiple printed copies of the document may be made. On receipt, the image objects in the document are compressed to form low resolution versions of the images for transmission to a user terminal during an editing process.

The page 100 of the original PDF shown in FIG. 2 includes a number of different text objects and image objects. A text title object 102 is located at the top of the page. A paragraphed text object 104 is located on the presented page 100 below the title object 102. Two image objects 106, 108 are positioned with different vertical offsets from the bottom of the paragraphed text object 104. A differently-formatted text title object 110 is located in the middle of the second column on the page, followed by a single paragraph text object 112. Two associated image objects 114, 116, are positioned above the title object 110. Note that, whilst the example paragraphed text object 104 shown is a single-column text object, the text object may span two or more columns of continuous text, which may be treated and edited as a single object in the process to be described below.

In the PDF document describing the page 100, various text presentation attributes which would be present in a word processing application document, for example a Microsoft Word™ application, are not explicitly defined. The lines of text in the paragraphed text object 104 are specified in the PDF document in terms of text strings and positioning thereof relative to the current text position. However, elements such as paragraph width, text alignment (e.g. left alignment, right alignment, centre alignment, justified alignment), carriage return and paragraphing operators, are not explicitly described in the PDF document. Rather, the PDF document describes explicitly the presentation of the objects on the page 100. Thus, the PDF document does not lend itself naturally to editing. Indeed, this was one of the original objectives in the development of the PDF format, namely that documents should be viewable and exchangeable without alteration of the content or the manner in which the content would be presented on the page.

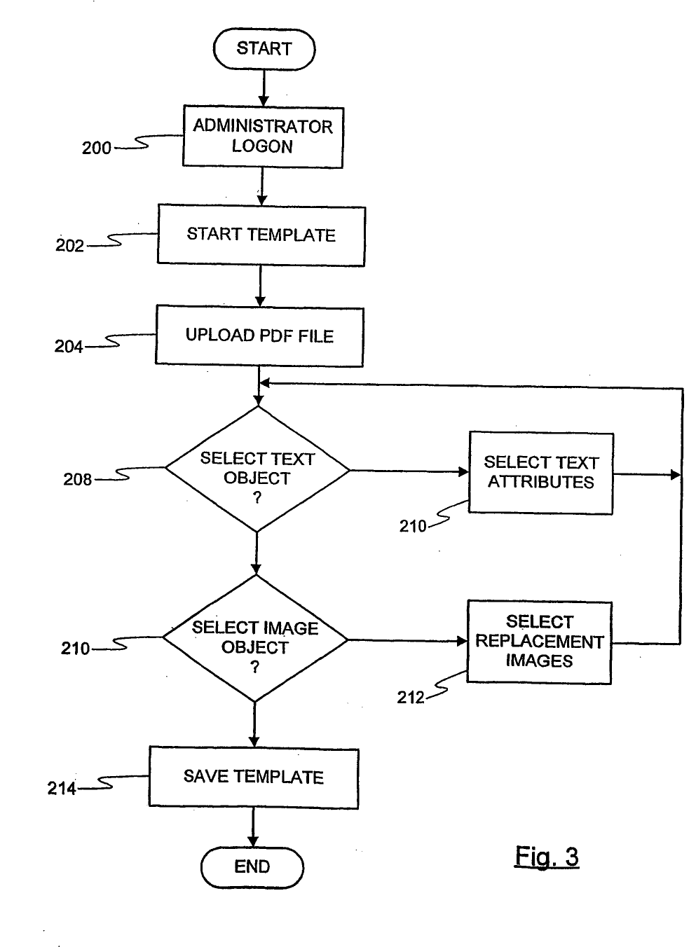

FIG. 3 illustrates steps taken by an administrator, using administrator terminal 30, to generate a document template using the ASP system 10. The document template is later used by the editing software 16 to automatically generate replacement objects when a user is producing an edited PDF file.

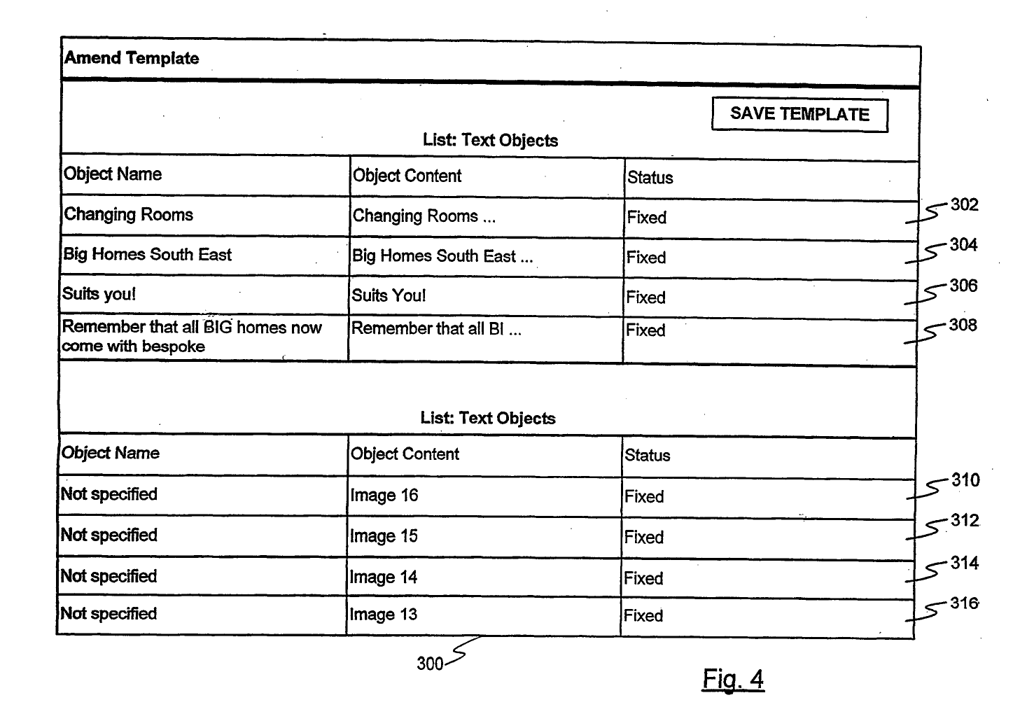

Initially, the administrator navigates to a Website address of the ASP system 10, and logs on, step 200, using a username and password specific to the administrator. Next, the administrator selects an option to start a new template for an original PDF file, step 202. The administrator uploads the original PDF file, step 204, to the ASP system 10, following which the ASP system 10 stores the original PDF in the original PDF database 20 along with a unique identifier. The template production software 14 of the ASP system 10 is then initialized with the original PDF document. The template production software traverses the entire document, identifying each object, including text objects and image objects, in turn. The template production software 14 automatically generates a name for each identified object, a text title being based on the start of the text content for a text object, and an image title being based on a numerical sequence allocated as each new image object is identified. The template production software 14 then transmits the data to the Web server software 18, which formats the information as a template summary Web page 300, as illustrated in FIG. 4. The template summary page 300 is transmitted to the administrator terminal 30, for viewing using the Web browser application 32.

As shown in FIG. 4, the template summary page includes a list of the identified text image objects. In the example based on the page 100 shown in FIG. 2, four text objects 302, 304, 306, 308, are identified, whilst four image objects 310, 312, 314, 316, are identified. By selecting one of the objects, the administrator is able to set up and amend template attributes for the object.

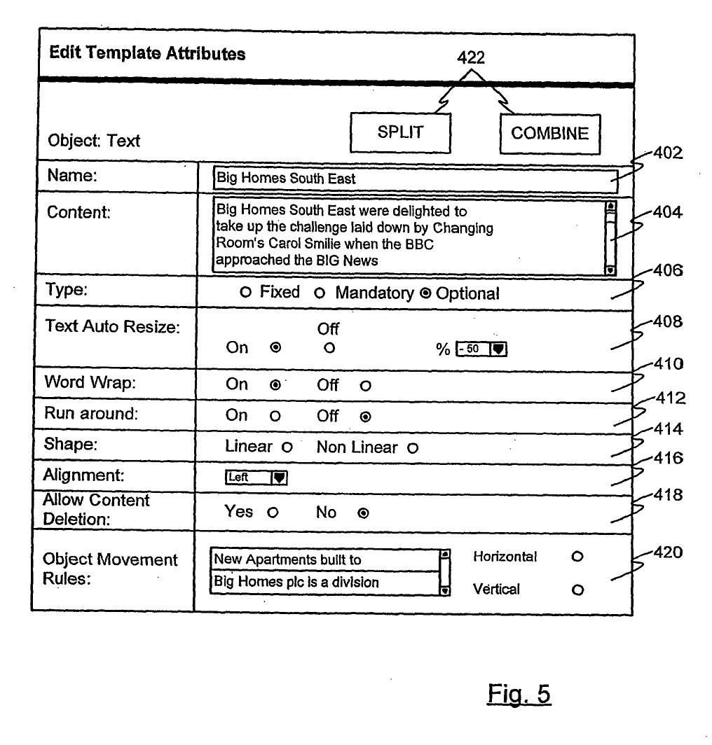

Reverting to FIG. 3, the administrator may select a text object, step 208, and edit the text attributes, step 210, before selecting another of the objects to set or amend its attributes. On selecting the text object in step 208, the template production software 14 is initialized with the original text object content in the form of character strings defining words, wordspacings and paragraph line wrap locations. The text object content is then passed to the Web server software 18 to generate a text object template editing page 400 as shown in FIG. 5. The page 400 is transmitted to the administrator terminal 30, to allow the administrator to select template attributes from a plurality of predetermined options provided on the text object template editing page 400. The page 400 includes a title entry 402, containing the automatically generated name of the text object, a text box 404, containing the original text of the text object which cannot at this stage be amended, and a variety of template attribute sets 406 to 420. Each of the attribute sets includes a set of selectable options, presented for example in the form of radio buttons and/or drop-down lists, whereby the administrator is able to select attributes to be set for the text object.

An object type option set 406 includes three mutually exclusive options, namely “fixed”, “mandatory” and “optional”. In the case of a fixed-type object, the object is specified to be non-editable and does not appear in the editable object list when a user is editing the document. Thus, the object is to be presented on a page in the edited document in the same manner as in the original document. In the case of a mandatory-type object, the object is specified to be editable, and editing of the text is mandatory. If an optional-type text object is specified, the text in the object is set as editable, and the text object may optionally be edited.

The status of each of the objects, when initially listed by the template production software, is set by default as being a fixed-type object. Objects only then become editable by a user if the administrator specifically sets the object to be either of the mandatory or optional types.

A text auto-resize attribute options set 408 include text auto resize on, text auto-resize off, and a text auto-resize lower limit box, which allows the administrator to set a lower limit to which the text may be automatically resized by the editing software 16 if the text auto-resize on attribute is selected by the administrator.

A word wrap options set 410 includes a word wrap on attribute and a word wrap off attribute. If word wrap on is selected, the text object is specified to be capable of being presented in a multiple-line format, with the editing software 16 automatically selecting a location within the replacement text at which the replacement text is to be wrapped onto a different line of text.

A run around options set 412 includes a run around on attribute and a run around off attribute. If the run around off option is selected, all of the lines of the text object are fitted to a common maximum line length. The lengths of some individual lines of the replacement text object may exceed the lengths of the corresponding individual lines in the original text. This occurs if the corresponding individual lines of original text have lengths which are less than the maximum line length and the replacement text fits the maximum line length better than the original text.

If the run around on option is selected, the existing text within the text object, which consists of multiple lines of text, is deemed to have been designed with lines of various different lengths. For example, in a desktop publishing application, such as QuarkXPress™, an image object may be positioned on the page such that the image object falls within the boundaries of a text column. In this case, the lines of text are positioned, and their lengths are limited, such that the text follows the boundaries of the image object. Whilst this information is not included within the original PDF document, the administrator 30 is able to view the original PDF document, determine visually whether the text runs around any of the image objects in its vicinity, and set the run around attribute accordingly. If the run around on attribute is selected, a set of run around shape options 414 are selectable. One option is that the run around shape is linear, whilst the other option is that the run around shape is non-linear. The administrator is able to view the original PDF document and determine whether the run-around has a linear (generally vertical) outline, such that the text lines maybe selected to have a similar maximum line length where the text runs around the object. If the outline of the run-around is non-linear, each line of the text object may have a different length to correspond with the shape of the image object boundary.

An alignment options set 416 is provided to allow the administrator to select whether the text alignment is left-aligned, right-aligned, centre-aligned or justified (not shown). Whilst this information is not included within the original PDF document, the administrator is able to view the PDF document and determine an appropriate setting.

A content deletion attribute options set is selectable using radio buttons 418 to define whether the user may delete the object's contents entirely.

An object movement rules attribute options set 420 is selectable using drop down object selection list and “horizontal” and “vertical” selection radio buttons. If the text object is to be aligned with a further object on the page, the administrator selects the other object from the drop down list and selects the “horizontal” radio button. In this case, the selected object is horizontally repositioned on the page during editing in accordance with the size of the replacement text when presented on the page. For example, a title text object may, when edited, have an associated “align with object” selection, which is then automatically repositioned by the editing software 16 to be positioned with a predetermined distance from the end of the title text, irrespective of the length of the title.

If an object is to be moved into the place of this object if the object content is deleted or shortened in vertical length in the edited document (an empty text string is inserted), the administrator selects the appropriate object from the drop down list and selects the “vertical” radio button. In this case, if the object is deleted, the replacement content for the other object inherits the starting coordinates of the original object on the page. If the object is shortened in vertical length, the other object's starting coordinates are moved upwards by the corresponding amount. Note that the object selection list is a scrollable multiple selection box that allows the user to align more than two objects for movement together by holding down the keyboard “shift” key. For example, in the case of vertical alignment on a business card containing a name, job title, mobile number, telephone number, and fax number in descending order, the user can select both the telephone number and fax number to move up should the mobile number be deleted, and so forth.

“Split” and “Combine” option selections 422 provide the ability to separate and combine text objects. Using the separate and combine functionality, objects can be either “split” into separate components and have separate attributes applied to each component or “combined” to form a single component having a single set of attributes applied to each of the combined objects. In subsequent processing, the relevant objects are not actually split or combined but appear as such to the user.

An edit order option set (not shown) allows the administrator to select the order in which the editable objects are presented to a user when performing the editing process.

The page 400 may also include an option (not shown) allowing the administrator to select whether the user is able to alter the font used in the replacement text option, by selection of an alternative embedded font from those available with the original PDF document.

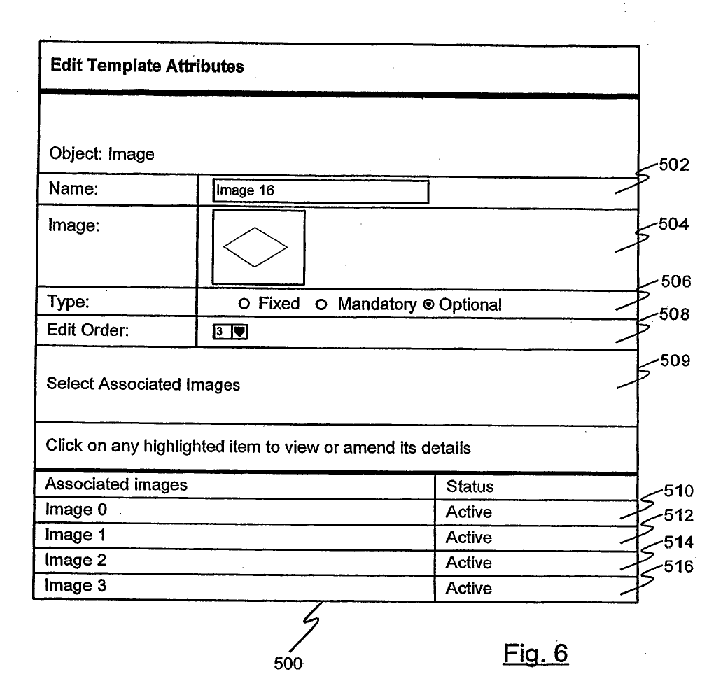

Reverting to FIG. 3, if an image object is selected in step 210, the administrator is able to select template attributes for the image object. FIG. 6 illustrates an image object template editing page 500 which is generated using template production software 14 and Web server 18. The image object template editing page 500 is transmitted to the administrator terminal 30 to allow the administrator to select the image object template attributes. The page 500 includes the image name 502, a low-resolution version of the image 504, an object type option set 506 corresponding to the type option set 406 for the text object template editing page and an edit order option set 508 corresponding with the edit order option set 420 in the text object template editing page. A template image selection button 509 allows the administrator to upload alternative template images for the currently selected object to template image database table 22. A set of associated image selections 510, 512, 514, 516, consisting of images uploaded by the administrator to the template image database table for specific use in relation to the current image object are shown on the editing page 500. The set of template images selected by the administrator are those which the editing software 16 will present to a user as replacement image options when editing the original PDF document. Alternatively, an image library module (not shown) allows the administrator to upload unlimited replacement images to a central image library database table. Such images can be deployed across a range of templates, users and specific image objects within individual templates dependent on end-user access rights set up and controlled by the administrator.

Reverting to FIG. 3, once the administrator has identified all objects which are to be editable, the administrator then selects an option presented on the template summary page 300 to save the template, in which case the template attributes selected for all editable objects are entered to the document template database 24 by the template production software 14, step 214.

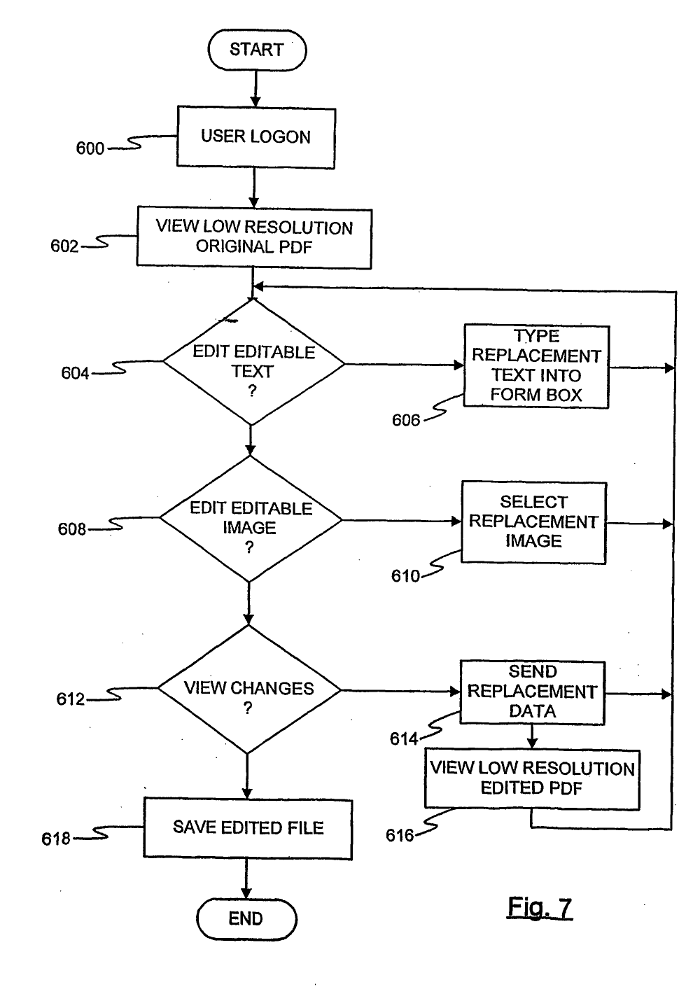

Once a template has been specified by the administrator, a user is able to log in to the ASP system 10 and produce an edited PDF document based on the original PDF document, in which the editing process is controlled by the editing software 16 using the original PDF document itself and the document template which is being specified for it. The editing process is illustrated in the flowchart of FIG. 7.

Initially, the user navigates to a Website provided on Web server 18 of the ASP system 10, and logs in using a user-specific username and password, step 600. The user may then be presented with one or more possible editable documents. On selecting one of the editable documents, the Web server 18 transmits a Web page to the user terminal 40, which is displayed by way of browser 42 on display device 46, containing for increased transmission speed a low resolution version of the original PDF 20. To produce the low resolution version, the editing software 16 produces low resolution versions of the images within the PDF document, and replaces the original images with these low resolution versions. The document is then viewed using the PDF viewer application 44. Also sent is a Web page containing text input boxes and hyperlinked low resolution versions of the associated template images which are selectable to allow the user to specify a replacement image to be placed in the edited PDF document.

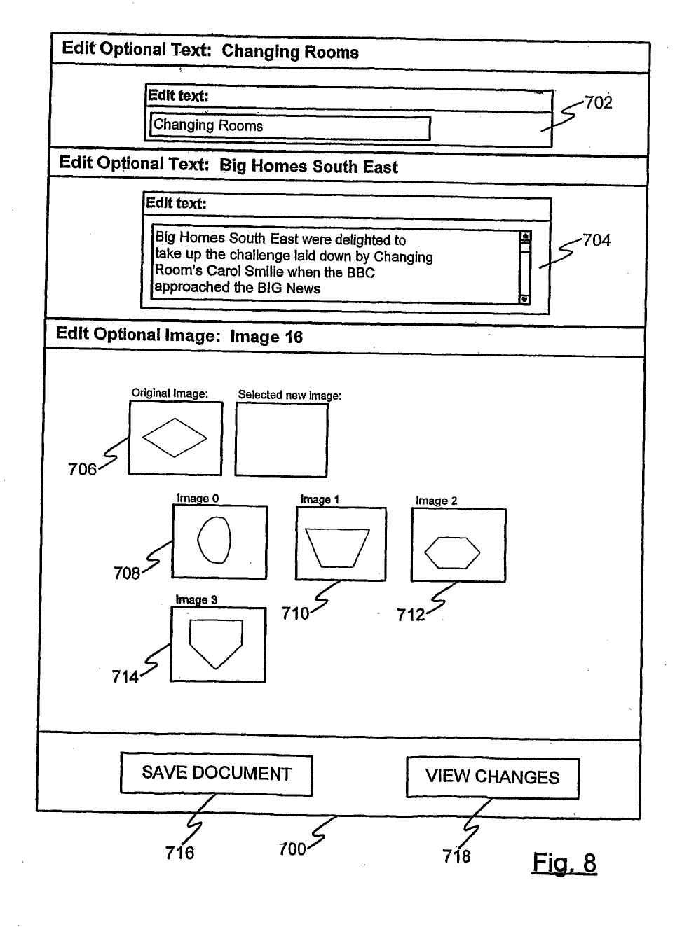

FIG. 8 illustrates the object editing Web page 700. The object editing Web page 700 includes a text editing box 702 corresponding to a single line text object which has been specified as optional or mandatory in the document template, a further text editing box 704 showing text from a further editable text object, which is a paragraph of text, and an image selection part includes a low resolution image in the form of an original image 706 and hyperlinked images 708-714 which selectable to select a replacement image for an editable image object. On selecting to edit the editable text object, step 604, the user types the replacement text into the form box, 606. By using a “choose font” option (not shown) the user may also choose an embedded typeface from those available within the original PDF document if the administrator has chosen to allow this feature. On selecting to edit an editable image, step 608, the user simply clicks on a replacement image from the set of replacement images 708, 710, 712, 714, which is presented in association with the original image, step 610.

The user is then able to select a “view changes” hyperlink 716, step 612, in which case the user terminal 40 transmits the form data and data confirming the selected replacement image(s) to the Web server 18. On receipt of the replacement data from step 614, the editing software 16 runs text manipulation routines, to be described in further detail below, to process the replacement text and the replacement image selections to generate an edited PDF document containing low resolution image objects. The edited PDF document is then transmitted, in low resolution form, to the user terminal 40, to allow the user to view the edited PDF, step 616. The document as edited may be saved in draft form and editing may continue in a separate session.

When the user is satisfied that the document is finalized, the user selects a “save document” hyperlink 716, in which case the production server 19 generates a high resolution edited PDF file, containing high resolution versions of all its images, and saves the edited PDF document to the edited PDF database 26. On saving the edited PDF document, the user is able to place an order, which in turn enables the administrator to download an automatically-generated high resolution edited PDF document direct from the production server 19, and may disseminate and/or output the document to print from a high-resolution printing device using printing software 52 and print job server 54. In addition, the end-user is able to view, download and print a low resolution version of the edited PDF document at any time.

Alternatively, on saving the edited files, the user is able to download the automatically-generated high resolution edited PDF document direct from the production server 19, and may disseminate and/or output the document to print from the user terminal 40.

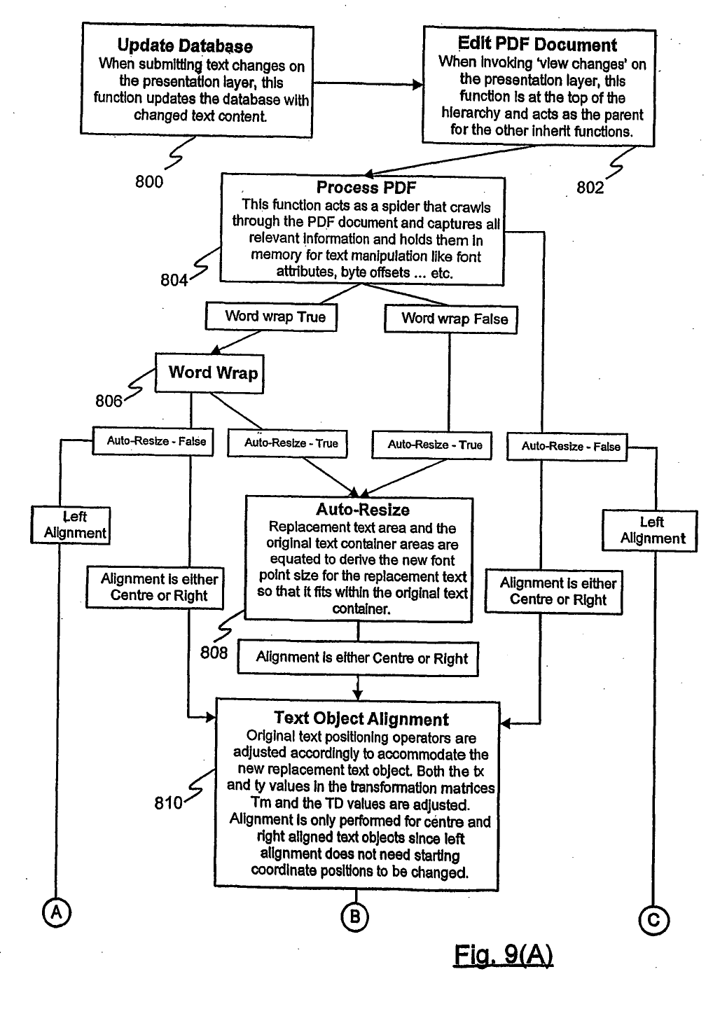

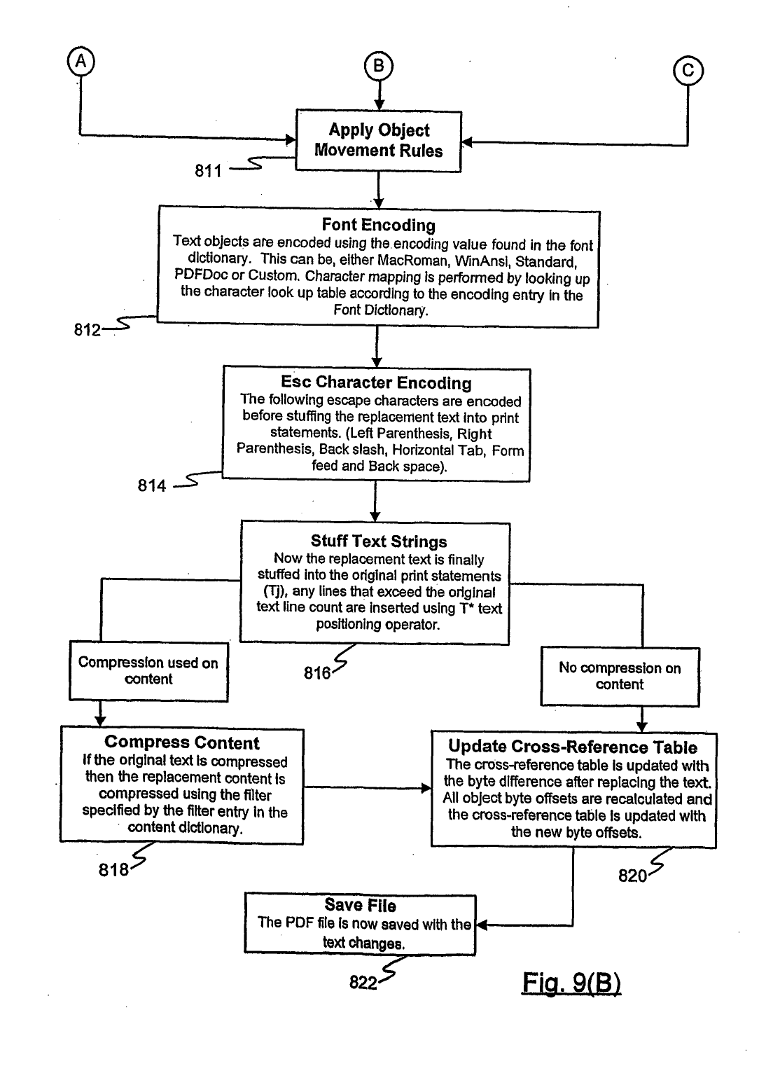

FIGS. 9(A) and 9(B) show a flow diagram illustrating the text manipulation routines carried out by the editing software 16 in receipt of replacement text during the editing process. In a first step, step 800, the replacement text when submitted from the object editing Web page 700 is stored by the Web server 18. When the user then invokes the “view changes” option, the editing software initiates an automated PDF text object generation algorithm, step 802. In a first step of the automated processing, step 804, the editing software 16 processes the original PDF document to search for all original text presentation attributes relating to the original text object, including text presentation attributes which are held in the corresponding original text object. The editing software 16 then proceeds to generate a second text object corresponding to the original text object by processing the replacement text, utilizing both the corresponding document template attributes defined for the object and the original text presentation attributes from the first, original text object, and predetermined text manipulation routines which are applied to the replacement text to generate the second, replacement text object.

If the word wrap on attribute is defined in the document template, a word wrap routine 806, whereby the replacement text is automatically word wrapped, is initiated to fit each line of the replacement text in accordance with the appropriate template run around attribute which has been set. To fit a line, possible breaks within the line of text are identified by means of standard word separators, such as a period character, a comma character, a hyphen character, a colon character, a semi-colon character, etc, defining the locations within the text at which it is possible to wrap the text to the next line. A closest fit is chosen such that the line has a total length which is equal to or smaller, but as close as possible to, the original line length in user space. The editing software 16 calculates the lengths of a line of original or replacement text in user space by adding together the horizontal displacement of each glyph in the line, as well as any character or word spacing parameters in the text state, and applying any necessary transformation to generate a line length in user space.

In the word wrap routine 806, the run around attribute in the document template is queried. If the run around off attribute is specified, then the replacement text is wrapped, line by line, to fit within the maximum width of the original text container. The longest of the original text lines within the text object is then selected as the maximum allowable line width for the text object. Each line of the replacement text is then wrapped to fit within the calculated maximum line length.

Thus, in the case of run around off attribute being specified, the replacement text is manipulated to select a plurality of locations within the replacement text at which the replacement text is to be wrapped onto a different line of text by calculating a maximum length of one or more lines of text from the original text object, and automatically fitting each of a plurality of lines of text within the replacement text object to the calculated maximum length.

If the run around on attribute is selected in the document template, then each line of the replacement text is wrapped to the corresponding original text line length. Thus, the length of each line in the original text object is calculated, by adding the glyph widths consecutively, and the corresponding line in the replacement text object is wrapped at a location containing a standard word separator such that the text automatically fits within the original line length.

The word wrap routine uses font widths, character spacing and word spacing to calculate the coordinate length of text strings and standard word separators are used to select potential wrapping locations within a line. When more than one font attribute is used on any of the text objects then the width calculation on the text string is performed by taking each font's corresponding widths array in order to calculate the replacement text string's required maximum width to fit within the original container.

The replacement text is then fitted within the original text line length by ensuring that the replacement text line length, in user space, is equal to or less than the line length to which it is being fitted, whilst the last standard word separator identified within the replacement line of text is used so that the replacement line length is as close as possible to the original line length.

If the auto-resize on attribute is selected in the document template for the text object being processed, the editing software 16 performs an auto-resize routine 808, whereby the replacement text area and the original text container areas are equated to derive a new font point size for the replacement text so that it is fitted closely with the original text container. Thus, if the replacement text has fewer characters than the original text, or more precisely, the characters of the replacement text, when rendered in the original font point size, create a smaller line length than the line length of the original text, the font size for the replacement text is increased such that the replacement text, when presented on a page, has a horizontal width which is fitted closely with the horizontal width of the original text content. The font size is thus automatically selected in the replacement text object, whilst the font specified in the original text object is maintained. Preferably, the new font size is selected so that the replacement text has a line length which is less than the original line length, but which is as closely fitted thereto as possible by selecting a font size above which the object would fall outside the original text length. The auto-resize option is particularly suited for single lines of text, such as text headings. If the auto-resize off attribute has been selected, the original font point size is maintained irrespective of the amount of replacement text input.

If the text alignment attribute in the document template for the text object being manipulated is either centred or right, a text object alignment routine 810 is performed by the editing software 16. Using the text object alignment routine, the original text positioning operators are automatically adjusted according to the specified alignment attribute.

Where the alignment attribute is left-aligned, the original text positioning operators are used unadjusted. If the text positioning operators are to be adjusted, a length comparison is performed for each line between the original text and the replacement text. The first line coordinate length difference is added to the e or f component of the transformation matrix Tₘ (as described above), depending on the original writing mode, i.e. horizontal or vertical writing modes. All succeeding line coordinate length differences are added to the preceding relative text positioning operator's horizontal coordinate. The length differences are also computed and the appropriate text positioning is applied for central alignment.

Once the word wrap, auto-resize and text object alignment routines are performed, if appropriate, to generate replacement text object attributes, an object movement routine is performed, step 811. If object movement rules are set in the template, in which the object is associated with another object, the object's starting coordinates are altered to move the object into its appropriate place on the page.

Next, in a font encoding routine 812, text objects are automatically encoded by the editing software 16 using the encoding value found in the fonts dictionary. A PDF-compatible font encoding mechanism is used, such as StandardEncoding, MacRomanEncoding, WinAnsiEncoding, PDFDockEncoding, MacExpertEncoding and CustomEncoding. Characters are mapped accordingly in print statements according to the font encoding entry specified in the font dictionary.

Next, an escape character encoding routine 814 is carried out to encode escape characters separately, the escape characters being left parenthesis, right parenthesis, backslash, horizontal tab, form feed and backspace. This separate process is used since some of the characters are used by PDF as internal operators, and others cannot be inserted directly into print statements according to the PDF file format specification, Version 1.3.

After escape character encoding, a stuff text strings routine 816 is carried out to stuff the replacement text into the original print statement (Tj). Any lines that exceed the original line text count being inserted using the T* text positioning operator. When multiple font attributes have been selected by the user within a text object then a text line is split into different print statements according to the way the multiple fonts have been set for that particular line. This involves the calculation of the horizontal position of the TD operator that is used to split the text lines.

If the original content is compressed, a compress content routine 818 is then used, whereby the replacement content is compressed using the filter specified by the filter entry in the content dictionary. Finally, an update cross-reference table routine 820 is carried out to update the original cross-reference table with the byte differences after the replacement of the text. All object byte offsets are recalculated and the cross-reference table is updated with the new byte offsets. Finally, the PDF file is saved with the edited text object as generated by the editing software 16, step 822.

The replacement text object includes various presentation attributes inherited from the original text object, such as the selected font type and the text line start position if for example the text object is left aligned. Other attributes specified by parameters in the replacement text object are generated by the editing software 16 by calculations which take into account both the original text presentation attributes and attributes defined in the document template, for example the word wrap on attribute and the word wrap off attribute.

Taking the case of Example 1 described above, use of the text manipulation routines carried out by the editing software would allow a user to simply replace the text ABC on the page without having to redefine other attributes of the object. Certain other attributes may be altered automatically in dependence on the template attributes. Example 2 below shows a simple edited version of the text object. The text object presents the text WXYZ on the page with a start point ten inches from the bottom of the page and four inches from the left edge, using 12-point Helvetica. In this case, the auto-resize off template attribute is set. All the user would have entered is the replacement text “WXYZ” during the editing process; the remaining operations in relation to the text object are carried out automatically by the editing software 16.

### EXAMPLE 2

BT
/F13 12 Tf
288 720 Td
(WXYZ) Tj

ET

If on the other hand, the auto-resize on template attribute is set, the editing software may resize the text font and automatically generate a replacement text object as shown in Example 3 below. Again, all the user would have entered is the replacement text “WXYZ”. In this case the object presents the text WXYZ on the page with a start point ten inches from the bottom of the page and four inches from the left edge, using 11-point Helvetica.

### EXAMPLE 3

BT
/F13 11 Tf
288 720 Td
(WXYZ) Tj

ET

It should be understood that, in the case of more complex text objects and other text manipulation processing, other presentation attributes of the text may be amended or maintained in order to produce the replacement object from the original object.

The user may also edit an editable image object, as described above. In this case, the editing software automatically generates a replacement image object which is added to the edited PDF file and which substitutes the original image object. The positioning of the original image object is maintained in the replacement image object, whilst the image content is altered.

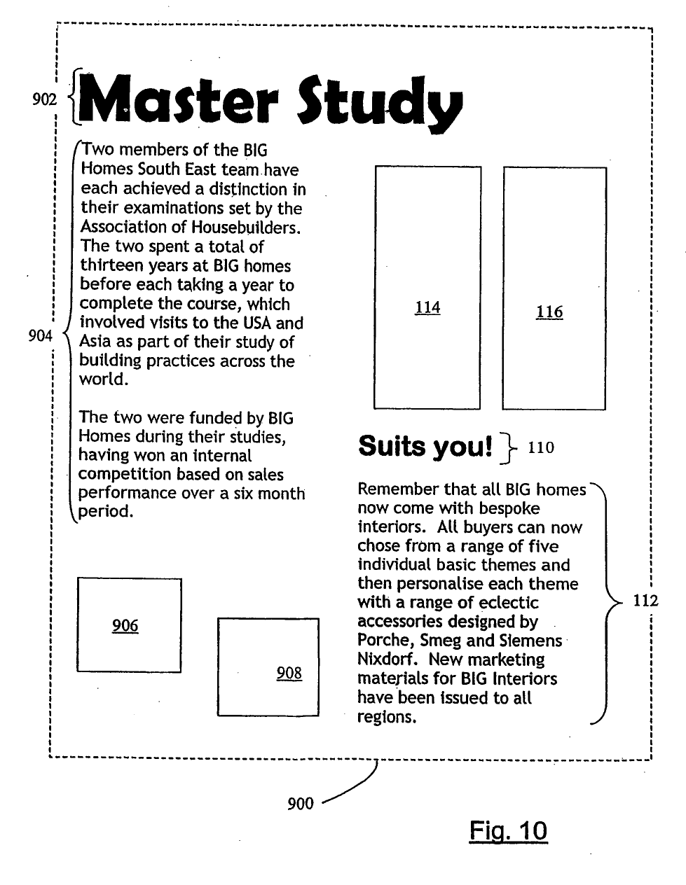

FIG. 10 illustrates an example of an edited page 900 corresponding to the original page 100 illustrated in FIG. 2. In this case, the upper title object 102 was specified within the document template to be editable and having the auto-resize attribute off. The edited PDF document presents the replacement text “Master Study” with the same font selection and the same font point size, and the same line start position as the corresponding text object from the original PDF document. The original text from the paragraph text object 104 was specified in the document template as being editable, to have the word wrap on attribute, to have the run around attribute off, to have left alignment, and to be non-aligned with another object, as illustrated in the selections shown in FIG. 5. The editing software thus has produced a replacement text object 904 as shown in FIG. 10 which shares line positioning characteristics with the original text object 104, but in which the replacement text has been wrapped at line lengths which all fit within a maximum line length seen in the original text object 104, since the run around off attribute has been set for the object.

Furthermore, replacement images 906 and 908 have been presented at locations identical to those of the original images 106, 108.

Regarding the remaining objects seen in the original page 100, the template for the document produced in the page 100 was set up such that these further text objects were of a fixed type, and therefore the original objects are presented in the page for the edited PDF document 900.

The above embodiments are to be understood as illustrative examples of the invention. Further embodiments of the invention are envisaged. For example, whilst the document template may hold data specifying one attribute for one of the editable objects, and a separate, associated attribute for a different editable object, only one of the associated attributes needs to be specified in data held in the document template database 24. The other attribute may be set by default. For example, the object type attribute may be set to a fixed-type attribute by default. Data is then only necessarily stored in the template to specify when the object is non-fixed, i.e. editable. The same applies to other associated attributes specifiable within a template, such as wrappable/non-wrappable, linear/non-linear, etc.

It is to be understood that the automated text object manipulation procedures described above are not to be taken to be limiting. In addition to or alternative to the cases described above, any of the original text presentation attributes defined in a text object, for example the text leading parameter, may be either maintained or replaced in the process of automatically generating the text object, in dependence on a selection of template attributes defined for the text object and/or the automated text manipulation operations performed by the editing software in the automated object editing process.

Whilst in the above, various of the original presentation parameters are described as being maintained in the edited document, other attributes may also be maintained. Such attributes include angled text, anchored text, text on a path (such as a circular path), tracking and kerning attributes.

Whilst in the above embodiments the administrator manually selects and sets the various template attributes, the template production software 14 may automatically select and set one or more of the various attributes. For example, in the case of a left justified text paragraph, the common horizontal starting coordinates of each successive line of text in an original text object may be detected by the software 14 to select and set a “left-justified” attribute. Such an automatically-detected attribute may be manually overridden on the template attribute editing page 400.

It is envisaged that, rather than automatic extraction of all objects taking place at the point of upload, in a further embodiment a manual software tool is provided to allow the user to manually select objects for extraction prior to upload thereby restricting the set of extracted objects to those which are required to be editable only.

Whilst the above embodiments relate to the processing of a PDF document, it should be understood that the invention is not limited thereto; the invention may also be used in the editing of other document formats, for example Encapsulated PostScript™ (EPSF) file formatted documents.

Furthermore, equivalents and modifications not described above may also be employed without departing from the scope of the invention, which is defined in the accompanying claims.

According to a first further aspect of the present invention there is provided computer software adapted to perform the method of the invention.

According to a second further aspect of the present invention there is provided data processing apparatus adapted to perform the method of the invention.

According to a third further aspect of the present invention there is provided a method of operating a Web browser software application to produce a document template whereby a second electronic document, which is an edited version of a first electronic document, may be generated using computer software,

wherein the first and second electronic documents define the presentation of elements on at least one page when presented on an output device, the documents each comprising a plurality of text objects to be presented as textual elements in a page, each of the text objects comprising original text defining a plurality of textual characters, and original presentation attributes defining characteristics of the presentation of the original text of the text object on a page, the method comprising:
in a template production process, using the Web browser software application to generate a document template by selecting at least a first said text object in the first electronic document and associating one or more template attributes with the first text object, said one or more template attributes not being explicitly defined in the first document, and to transmit the template attributes via a data communications network to a remote data processing device for, in an editing process, enabling computer software to:
receive replacement text to replace at least part of the original text of the first text object;
automatically generate a second text object using the replacement text and one or more of the original presentation attributes of the first text object; and
automatically generate the second electronic document, which includes the second text object, such that the second electronic document accords with the document template.

According to a fourth further aspect of the present invention there is provided a method of operating a Web browser software application to produce a second electronic document which is an edited version of a first electronic document using computer software,
wherein the first and second electronic documents define the presentation of elements on at least one page when presented on an output device, the documents each comprising a plurality of text objects to be presented as textual elements in a page, each of the text objects comprising original text defining a plurality of textual characters, and original presentation attributes defining characteristics of the presentation of the original text of the text object on a page, the method comprising, in an editing process, using the Web browser software application to:
access an editing form relating to a document template relating to the first electronic document, in which a first said text object in the first electronic document has one or more template attributes associated therewith, said one or more template attributes not being explicitly defined in the first document;
generate replacement text to replace at least part of the original text of the first text object; and
transmit the replacement text via a data communications to a remote data processing device for enabling computer software to:
automatically generate a second text object using the replacement text and one or more of the original presentation attributes of the first text object; and

automatically generate the second electronic document, which includes the second text object, such that the second electronic document accords with the document template.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method of processing a first electronic document using computer software to produce a second electronic document which is an edited version of the first electronic document,
wherein the first and second electronic documents define the presentation of elements on at least one page when presented on an output device, the documents each comprising a plurality of text objects to be presented as textual elements in a page, the text objects comprising original text defining a plurality of textual characters, and having associated therewith original presentation attributes defining characteristics of the presentation of the original text of the text object on a page, the method comprising:
in a template production process, using computer software to generate a document template by processing the first electronic document, selecting at least a first said text object in the first electronic document and associating one or more template attributes with the first text object, said one or more template attributes not being explicitly defined in the first document before the production of the template; and
in an editing process, using computer software to:
receive replacement text to replace at least part of the original text of the first text object;
automatically generate a second text object using the replacement text and one or more of the original presentation attributes of the first text object; and
automatically generate the second electronic document, which includes the second text object, such that the second electronic document accords with the document template.

2. A method according to claim 1, wherein the second text object comprises replacement presentation attributes different to the original presentation attributes, and one or more of said replacement presentation attributes are automatically generated in dependence on the replacement text.

3. A method according to claim 2, wherein said one or more of the replacement presentation attributes are automatically generated in dependence on the original text.

4. A method according to claim 2, wherein said one or more of the replacement presentation attributes are automatically generated in dependence on the document template.

5. A method according to claim 1, wherein the step of generating the document template comprises selecting the first text object and associating a template attribute with the first text object defining the first text object to have editable text, and/or selecting a different text object in the first electronic document and associating a template attribute with the different text object defining the different text object to have non-editable text.

6. A method according to claim 1, wherein the one or more template attributes associated with the first text object comprise one or more text manipulation attributes defining a respective characteristic of the presentation of the replacement text on a page, and the step of generating the second text object comprises using said one or more text manipulation attributes.

7. A method according to claim 1, wherein the step of generating the second text object comprises the computer software automatically selecting a location within the replacement text at which the replacement text is to be wrapped onto a different line of text.

8. A method according to claim 7, wherein the selection comprises the computer software calculating a length of a line of text from the first text object and automatically fitting a line of text from the second text object to the calculated length.

9. A method according to claim 7, wherein the step of generating the second text object comprises the computer software automatically selecting a plurality of locations within the replacement text at which the text is to be wrapped onto a different line of text.

10. A method according to claim 9, wherein the selection comprises the computer software calculating a maximum length of one or more lines of text from the first text object, and automatically fitting each of a plurality of lines of text from the second text object, to the calculated maximum length.

11. A method according to claim 9, wherein the selection comprises the computer software calculating a length of each of a plurality of lines of text from the first text object, and automatically fitting each of a plurality of corresponding lines of text from the second text object, to the respective calculated lengths.

12. A method according to claim 1, wherein the step of generating the document template comprises selecting the first text object and associating a template attribute with the first text object defining the first text object to have wrappable text, and/or selecting a different text object in the first electronic document and associating a template attribute with the different text object defining the different text object to have non-wrappable text.

13. A method according to claim 12, wherein the step of generating the document template comprises selecting the first text object and associating a template attribute with the first text object defining the first text object to have multiple lines of text arranged along a linear edge, and/or selecting the first text object and associating a template attribute with the first text object defining the different text object to have multiple lines of text arranged along a non-linear edge.

14. A method according to claim 1, wherein the step of generating the second text object comprises the computer software automatically selecting a font size for the presentation of the replacement text, which font size is different to a font size defined in the original presentation attributes for the first text object.

15. A method according to claim 14, wherein the font size is calculated with reference to a size of the original text object.

16. A method according to claim 14, wherein the step of generating the document template comprises selecting the first text object and associating a template attribute with the first text object defining the first text object to have resizable text, and/or selecting a different text object in the first electronic document and associating a template attribute with the different text object defining the different text object to have non-resizable text.

17. A method according to claim 14 wherein the step of generating the document template comprises selecting the first text object and associating a template attribute with the first text object defining the first text object to have text which is resizable within a specified limit, and selecting a different text object in the first electronic document and associating a template attribute with the different text object defining the different text object to have text which is resizable within a different specified limit.

18. A method according to claim 1, wherein the step of generating the second text object comprises the computer software automatically selecting a position of a line of replacement text, when presented on a page in accordance with the second text object, which is different to a corresponding position of a corresponding line of original text, when presented on a page in accordance with the first text object.

19. A method according to claim 18, wherein the position is the position of the first character in a line of text.

20. A method according to claim 18, wherein the selection comprises the computer software calculating a length of the line of text from the first text object, calculating a length of the line of text from the second text object and automatically calculating the position with reference to a positioning characteristic of the presentation of text on a page.

21. A method according to claim 18, wherein the step of generating the document template comprises selecting the first text object and associating a template attribute with the first text object defining the first text object to have text which is aligned in relation to the centre or right hand side of a line of text, when presented on a page, and/or selecting a different text object in the first electronic document and associating a template attribute with the different text object defining the different text object to have text which is aligned in relation to the left hand side of a line of text, when presented on a page.

22. A method according to claim 1, wherein the first and second electronic documents each comprise one or more graphics objects to be presented as graphical elements in a page, each of the graphics objects comprising a graphical image file, or a pointer thereto.

23. A method according to claim 1, wherein the step of generating the second electronic document comprises the computer software automatically adjusting a position at which the presentation of the content of a different object in the second electronic document is to occur on a page, in accordance with a position at which the presentation of text from the second text object is to occur on a page.

24. A method according to claim 23, wherein the step of generating the document template comprises selecting the first text object and associating a template attribute with the first text object defining the first text object to have text which is aligned in relation to a different object, when presented on a page, and/or selecting the different object in the first electronic document and associating a template attribute with the different text object defining the different object to have content which is aligned in relation to text from the first text object, when presented on a page.

25. A method according to claim 1, comprising generating an electronic document which is a lower resolution version of the first electronic document, and transmitting the lower resolution version of the first electronic document to a remote user via a data communications network during the editing process.

26. A method according to claim 1, comprising generating an electronic document which is a lower resolution version of the second electronic document, and transmitting the lower resolution version of the second electronic document to a remote data processing device via a data communications network during the editing process.

27. A method according to claim 1, comprising transmitting a data input form to a remote data processing device via a data communications network, and receiving the replacement text as form data from the remote data processing device.

28. A method according to claim 1, wherein the first document is a Portable Document Format (PDF) document.

29. A method according to claim 1, wherein the second document is a Portable Document Format (PDF) document.

30. A method of processing a first electronic document using computer software to produce a document template whereby a second electronic document, which is an edited version of the first electronic document, may be generated,
wherein the first and second electronic documents define the presentation of elements on at least one page when presented on an output device, the documents each comprising a plurality of text objects to be presented as textual elements in a page, each of the text objects comprising original text defining a plurality of textual characters, and original presentation attributes defining characteristics of the presentation of the original text of the text object on a page, the method comprising:
in a template production process, using computer software to generate a document template by processing the first electronic document, selecting at least a first said text object in the first electronic document and associating one or more template attributes with the first text object, said one or more template attributes not being explicitly defined in the first document before the production of the template, and storing the template attributes for, in an editing process, enabling computer software to:
receive replacement text to replace at least part of the original text of the first text object;
automatically generate a second text object using the replacement text and one or more of the original presentation attributes of the first text object; and
automatically generate the second electronic document, which includes the second text object, such that the second electronic document accords with the document template.

31. A method of processing a first electronic document using computer software to produce a second electronic document which is an edited version of the first electronic document,
wherein the first and second electronic documents define the presentation of elements on at least one page when presented on an output device, the documents each comprising a plurality of text objects to be presented as textual elements in a page, each of the text objects comprising original text defining a plurality of textual characters, and original presentation attributes defining characteristics of the presentation of the original text of the text object on a page, the method comprising, in an editing process, using computer software to:
access a document template relating to the first electronic document, in which a first said text object in the first electronic document has one or more template attributes associated therewith, said one or more template attributes not being explicitly defined in the first document;
receive replacement text to replace at least part of the original text of the first text object;
automatically generate a second text object using the replacement text and one or more of the original presentation attributes of the first text object; and
automatically generate the second electronic document, which includes the second text object, such that the second electronic document accords with the document template.

32. A method according to claim 31, comprising generating a print job order including the second document, and transmitting the print job order to a remote data processing device.
